(19) United States
(12) Patent Application Publication
(10) Pub. No.: US 2013/0280691 A1
(43) Pub. Date: Oct. 24, 2013

(54) WRITE ERASABLE COMPONENT SYSTEM

(71) Applicant: Tim O'Connor, Oxford, MA (US)

(72) Inventor: Tim O'Connor, Oxford, MA (US)

(21) Appl. No.: 13/718,515

(22) Filed: Dec. 18, 2012

Related U.S. Application Data
(60) Provisional application No. 61/577,069, filed on Dec. 18, 2011.

(51) Int. Cl. B43L 1/10

(52) U.S. Cl. CPC B43L 1/10
USPC 434/408; 434/365

(57) ABSTRACT

A series of devices that allow for embedding of an image as a background while also affording the user the ability to write and print on the surface, with erasable capabilities, thus providing a multifunctional product for use in numerous industries. The devices are manufactured from predominately corrugated plastic. In one embodiment, a writable board, or peg board comprising a front panel and a rear panel wherein the panels are interconnected by parallel rows, or corrugations, these panels include a writable and erasable surface. The present invention relates to novel assemblies of conventional corrugated plastic sheets to better serve personal, business, and educational needs.

### CROSS REFERENCE TO RELATED APPLICATION

This application claims the benefit of and takes priority from co-pending U.S. provisional patent application Ser. No. 61/577,069, filed on Dec. 18, 2011, incorporated herein by reference.

### FIELD OF THE INVENTION

The present invention relates to write erasable configurations, signage and display materials and more specifically to imaging boards capable of displaying permanent images, temporary images, as well as providing erasable capabilities, that allows the user to have a solid writing or display surface that can retain permanent ink or semi-permanent ink, allowing the user to create and recreate on one or more surfaces.

### BACKGROUND OF THE INVENTION

Erasable surfaces, namely white boards or chalk boards, have long been used in the both office settings, construction sites and in the educational industry as well as in lower scale applications such as small business and personal use. These boards afford the user a surface that the user can write on and once finished, erase the written matter, rendering the surface clean and revealing any embedded image.

However, when white boards or similar erasable surfaces are used continuously for long periods of time the surface can retain ink from the erasable markers, and the surface can chip, ware generally, or loss the ability to erase. The expense of replacing white boards, particularly the large wall boards used in classrooms and business conference rooms, is high, so is maintenance and installation. Due to the size and weight of these boards professional labor is required.

Concurrent systems and designs have attempted to solve this problem by creating individual white boards that are lighter weight and more easily replaced, but these boards do not cover the need for large surface writing. Similarly concurrent systems and designs have created stick-on thin erasable surfaces that can peel away and be replaced. However, these surface lack durability and longevity. Ultimately, there is a need for a durable erasable surface that does not carry the expense of traditional surfaces and can not only last longer but can more easily be replaced.

And concurrent erasable surfaces can often be easily erased, particularly if a user is writing above or around previous writings their hand will smudge or erase the prior text completely. Concurrent systems and designs have created smudge protectors but those require the user to purchase and utilize an additional accessory limiting the ease of use. There is a need for a surface that can be erased but in the interim creates a semi-permanent ink that does not smudge or easily erase.

Also, concurrent erasable surfaces do not possess the ability to use graphics or permanently create backgrounds. Most educators and professionals use projectors to temporarily through the create light display images on erasable surfaces and then write over those images so as to teach or instruct their audience. Permanently placing such an image on a standard white board would be expensive due to the lack of maneuverability of a heavy board and would if the user wanted to change the image it would be expensive to replace the board. Concurrent systems and designs have created advanced ink printing systems that can screen graph or quickly place an image on any surface or other plastic composite materials. However, these materials do not also have the ability to then be written on once printed on, or if they do the additional written ink is not erasable or is not erasable without damaging the background image. There is therefore a need for durable erasable surface that can hold permanent ink while allowing for semi-permanent ink on top of it.

Additionally, current erasable implementations are limited to uni-planar usage due to weight and mounting considerations. Most erasable surfaces that attached or adhered to other instruments or items are only capable of being used on one side of the item. Thus, a dual sided assembly that increases user access and overall function is preferable.

Furthermore, often times, the inks that are utilized are toxic in nature and give off fumes which can render the user nauseous and thus become almost unusable. And finally, concurrent erasable surfaces are inherently non-multifunctional. Current white boards are fairly standard and are found in square or rectangular shape and used solely as a linear board surface. Concurrent systems and designs normally feature adhering the boards to other surfaces such as desktops, but these designs all still only utilize the linear or planer dimension of the board. Erasable surfaces which can be manipulated and are capable of being implemented in diverse uses and maintaining structural integrity.

### SUMMARY OF THE INVENTION

The instant apparatus and system, as illustrated herein, is clearly not anticipated, rendered obvious, or even present in any of the prior art mechanisms, either alone or in any combination thereof. The versatile system, method and series of apparatuses for creating and utilizing a series of systems and apparatuses comprising reinforced and substantially composite write erasable surfaces are illustrated. Thus the several embodiments of the instant apparatus are illustrated herein.

It is primary object of the present multifunctional apparatus to introduce and utilize reusable, economical environmentally friendly, and long-lasting write erasable surfaces. Thus the surfaces created with the instant materials provide reusable, environmentally friendly, and long-lasting surfaces, which may also include an imbedded image or series of images while still retaining the write erasable capabilities.

It a primary goal of the present system to provide a lightweight, inexpensive, double sided assemblies of polymeric erasable boards, that, when imprinted with an image, may appear as a picture, or logo while simultaneously concealing an important private writing or documents on the rear side, or even attached pockets, all of which may be stored on the reverse side of what appears to be a painting. Thus it is an object of the present system to provide an erasable planning board, which simultaneously provides a great aesthetically and very pragmatic approach by allowing this board to be flipped and act as a picture or graphic art rendition while concealing information.

It is a primary goal of the present system to introduce numerous embodiments of structures, manufactures and items which allow erasable and layered printability. Also, a primary goal of the present system is to provide a lightweight, inexpensive, two-sided assemblies of polymeric erasable boards that may be used as a writing or drawing surface.

It is yet another object of the present system to provide assemblies of polymeric erasable boards may be digitally imprinted on one or two sides with a personalized image or logo and yet another object of the present system to provide assemblies of polymeric erasable boards that can receive writing that does not come off easily when brushed against, yet may be cleaned using water only and do not shadow.

It is yet another object of the present system to provide assemblies of polymeric erasable boards that are durable and have strong structure in all facets. Additionally, it is yet another object of the present system to provide assemblies of polymeric erasable boards that can be used in varied markets because of their numerous structures and ease of use and it is yet another object of the present system to provide assemblies of polymeric erasable boards that may be manufactured from recycled plastic and are 100% recyclable themselves.

It is yet another object of the present system to provide assemblies of polymeric erasable boards that through pinning, riveting and/or welding allows for framing and various constructions of the polymeric surfaces. It is yet another object of the present invention to provide assemblies of polymeric erasable boards that feature a hinge, by compressing a thin strip of a corrugated plastic sheet.

Briefly stated, the present system contemplates assemblies of polymeric, or composite, erasable boards having writable and erasable surfaces featuring a front panel and a rear panel, wherein the panels are interconnected substantially perpendicular rows, or corrugations. The assembly of polymeric erasable boards of the present invention can be adapted to be used as a white board, container, display, frames, notebooks, children's toys, books, pegboards, lap tables, easels, signage, storage organizations, and writable wall coverings and other numerous entities.

The configuration of the present system provides the user with a more functional polymeric erasable surface throughout their home, business, or school. The material is multicolored, foldable, stackable, recyclable, storable, mobile, compatible, reusable, inexpensive, able to personalized, efficient, erasable, easily installed, light weight, capable of having any shape. It is also water resistant, may include pockets for storage, and/or protective edges.

It is yet another object of the present system to incorporate construction methods including gluing, banding, tying, ring binding, pegging, Velro® bonding, pinning, four pronged, multi-planar pinning and multipronged, linear pinning.

The instant system of creating write erasable structures utilizable by people of all age groups, from drawing board and room restoration to dog house and doll house embodiments. Thus it is an objective of the present system to provide lightweight, portably disposed whiteboards, peg boards, binders, notebooks, multipurpose picture frames, writable erasable storage tools, writable erasable storage writable erasable storage writable erasable walls, boxes, rooms and structures in the entirety.

Thus it is an objective of the present system to create toys such as internally disposed series of dolls, writable surfaces for toys like Legos® type systems and storage systems that allow children to build, play within, write on and deconstruct the systems.

In more adult applications, hangers for coats, room signs and multifunctional, write erasable tool boards, kitchen boards, classroom boards and the like are envisioned. The positive features of the write erasable tool placement board, which also doubles as a multifunctional peg board, are particularly inherent as craftsmen often add tools to their arsenal. Thus, the instant system affords the user the capability to quickly and easily rearrange a tool board by erasing the current tool markings, removing the pegs and then drawing the new tool markings and positioning the pegs accordingly.

It is additionally an objective of the present system to utilize a Glycol ether or other like system to remove pen (which is not needed for water base) and water bases to remove many other writable means. Dry erasable markers may be used so that person can rub up against writing, but it won't come off and many issues water to get read. It is additionally an objective of the present system to introduce specialized pegs with pressurized materials.

The foregoing has outlined the more pertinent and important features of the present invention in order that the detailed description of the invention that follows may be better understood, and the present contributions to the art may be more fully appreciated. It is of course not possible to describe every conceivable combination of components and/or methodologies, but one of ordinary skill in the art may recognize that many further combinations or permutations are possible. Accordingly, the novel architecture described below is intended to embrace all such alterations, modifications, and variations that fall within the spirit and scope of the appended claims.

There has thus been outlined, rather broadly, the more important features of the versatile integrated write erasable board, functional peg board, and series of accompanying systems and apparatuses and embodiments in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

To the accomplishment of the foregoing and related ends, certain illustrative aspects are described herein in connection with the following description and the annexed drawings. These aspects are indicative of the various ways in which the principles disclosed herein can be practice and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

Advantages of the present invention will be apparent from the following detailed description of exemplary embodiments thereof, which description should be considered in conjunction with the accompanying drawings. Having thus described the invention in general terms, reference will now be made to the accompanying drawings, which are not necessarily drawn to scale, and wherein:

FIG. 1A illustrates an embodiment of the present invention, more specifically it illustrates the back, or decorated side of the polymeric erasable surface, including holes at the top and the bottom to reversibly fasten the assembly to a support surface and wherein there is also no requirement for holes as a user can pin right into the facing areas additionally as illustrated in the Figures below.

FIG. 1B illustrates the embodiment of the present invention shown in FIG. 1A, and more specifically it illustrates the front or writable side of the polymeric erasable surface, including holes at the top and the bottom to reversibly fasten the assembly to a support surface and wherein there is also no requirement for holes as a user can pin right into the facing areas additionally as illustrated in the Figures below.

FIG. 2A illustrates a side view of the embodiment of the present invention shown in FIG. 1A, highlighting the front and rear polymeric sheets connected by corrugations.

FIG. 2B illustrates the alternate side view of the embodiment of the present invention shown in FIG. 1A, highlighting the front and rear polymeric sheets connected by corrugations.

FIG. 3 illustrates a frontal view of an embodiment of the present invention namely, a notebook cover, with a hinge across the center to allow the notebook to be formed by folding over the hinge.

FIG. 4 illustrates a top view of the notebook of FIG. 3 in its folded form.

FIG. 5 illustrates a top view of an embodiment of the present invention, namely a box or envelope formed of the corrugated plastic sheets and suitable for use as a container or mailbox.

FIG. 6 illustrates a frontal view of an embodiment of the present invention, namely a special form of notebook which features a double hinge allowing the notebook to have depth creating a container.

FIG. 7 illustrates a frontal view of an embodiment of the present invention, namely a laminate screen adhered to the polymeric erasable surfaces for increased functionality.

FIG. 8 illustrates a frontal view of an embodiment of the present invention, namely a freestanding sign wherein the corrugated polymeric or plastic sheets can be bent to form an A-frame.

FIG. 9 illustrates an end view of an embodiment of the present invention, namely a lap table or shelf where a corrugated plastic sheet is folded and bonded.

FIG. 10 illustrates a top view of an embodiment of the present invention, namely the lab table shown in FIG. 9.

FIG. 11 illustrates an elevation view of a pin or rivet used to connect various pieces of the corrugated plastic sheet used in the embodiments of the present invention.

FIG. 12 illustrates an elevation view of a pin or rivet used to connect various pieces of the corrugated plastic sheet used in the embodiments of the present invention.

FIG. 13 illustrates an elevation view of a pin or rivet used to connect various pieces of the corrugated plastic sheet used in the embodiments of the present invention.

FIG. 14 illustrates an elevation view of a pin or rivet used to connect various pieces of the corrugated plastic sheet used in the embodiments of the present invention.

FIG. 15 illustrates a frontal view of an embodiment of the present invention, namely a stack of the corrugated plastic sheet. The sheets can be bonded to one another completely in order to form a more rigid structure. Alternatively, the sheets can be bonded to a hinge at one edge to form a book of sheets.

FIG. 16 illustrates a frontal view of an embodiment of the present invention, namely a board with a tray, where a corrugated plastic sheet is folded and bonded twice.

FIG. 17 illustrates a frontal view of finishing edges that can be used in any of the embodiments of the present invention.

FIG. 18 illustrates a frontal view of an embodiment of the present invention, namely a workbench board with permanent outlines for tool and instrument placement.

FIG. 19 illustrates a frontal view of an embodiment of the present invention, namely a book of multiple sheets of corrugated plastic, complied using rings and without any permanent imaging.

FIG. 20 illustrates a frontal view of an embodiment of the present invention, namely a notched form of the corrugated plastic sheet.

FIG. 21 illustrates a frontal view of a clasp that could be used to reversibly fasten various sheets of corrugated plastic sheet together.

FIG. 22 illustrates a photograph capable smart phone or tablet. As an alternative to typing textual messages or placing images into a transmission by the smart phone, a message could be permanently or erasably written or sketched on a piece of the corrugated plastic sheet. The user could then take a picture of the text or image and e-mail that picture to a user who would then be able to receive and read the message. This would be particularly useful for users who were not comfortable or skillful using the tiny keyboards normally available on smart phones or tablets. Because the message could be one of several messages prepared ahead of time and only photographed and transmitted at the appropriate time, this process could provide some unique capabilities.

FIG. 23 illustrates a front isometric view of a multipronged pin apparatus which is utilized to join individual elements of the write erasable, corrugated system wherein the double pin configuration eliminates rotation on the corners.

FIG. 24 illustrates a rear isometric view of a multipronged pin apparatus which is utilized to join individual elements of the write erasable, corrugated system.

FIG. 25 illustrates a variety of the different affixing or hanging elements which may be utilized with the individual elements of the write erasable, corrugated system.

FIG. 26 illustrates a rear isometric view of a multipronged pin apparatus including a rubberized or polymer protection mechanism.

FIG. 27 illustrates an additional a variety of the different affixing or hanging elements including cotter styled pins which include extended prong, chisel point and hammerlock styles, among others.

FIG. 28 illustrates a multipurpose, write erasable, storage and/or carrying case apparatus which may be configured to allow for the mounted mailbox, a mounted or portable toolbox, a storage bin system, a stackable bin system and any number of storage or containment apparatuses.

FIG. 29 illustrates a lightweight multipurpose, corrugated paint assistance mechanism which may be utilized in tandem with a brush or a roller.

FIG. 30 illustrates a glycol ether erasable coating or any other genre of coating which may be utilized to enhance erase ability on the note book, or any of the instantly presented systems.

FIG. 31 illustrates a multipurpose instant notebook mechanism or binder mechanism and also illustrates a securing flap and a button, latch or other securing mechanism, utilized to lock the notebook or binder.

### DETAILED DESCRIPTION OF THE INVENTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

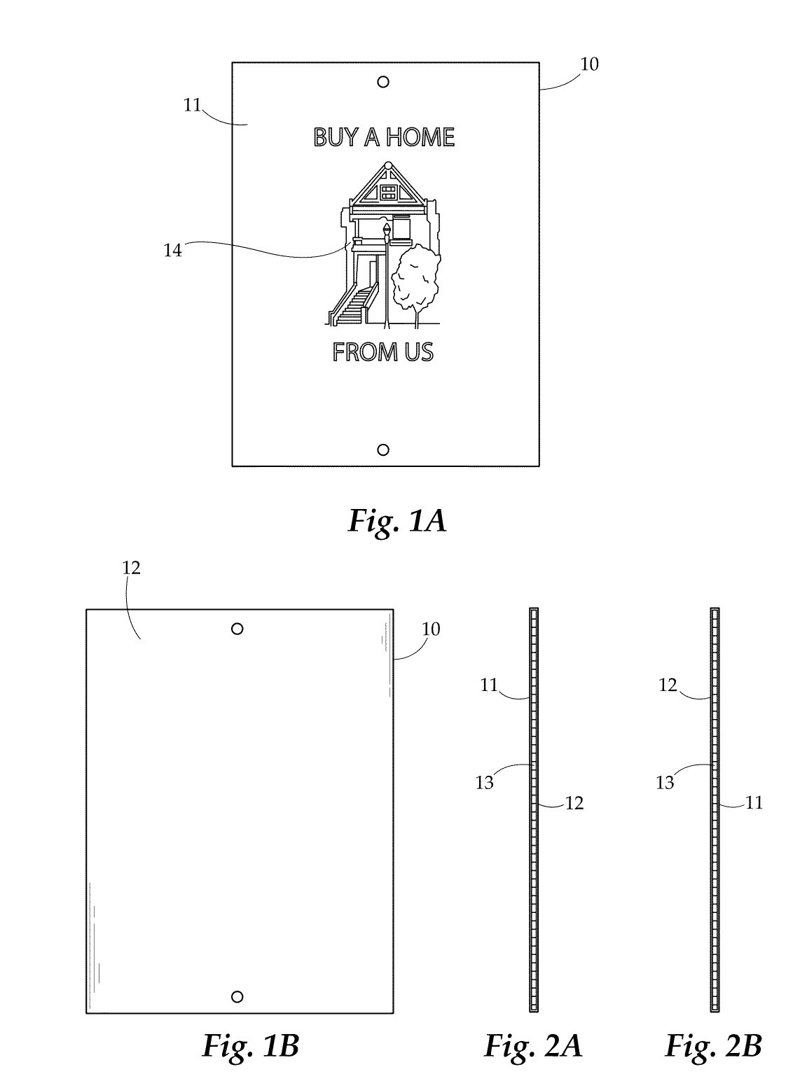

Turning now descriptively to the drawings, FIG. 1A illustrates a standard sheet of the polymeric erasable assembly 10 in use with an example of permanent imaging or design 14 on the front surface 11. FIG. 1B illustrates the rear surface 12 of the polymeric sheet. The composition of the polymeric erasable assembly 10 is better depicted in FIG. 2A. Comprising of a front panel 11 a rear panel 12 wherein the panels are interconnected parallel rows, or corrugations 13.

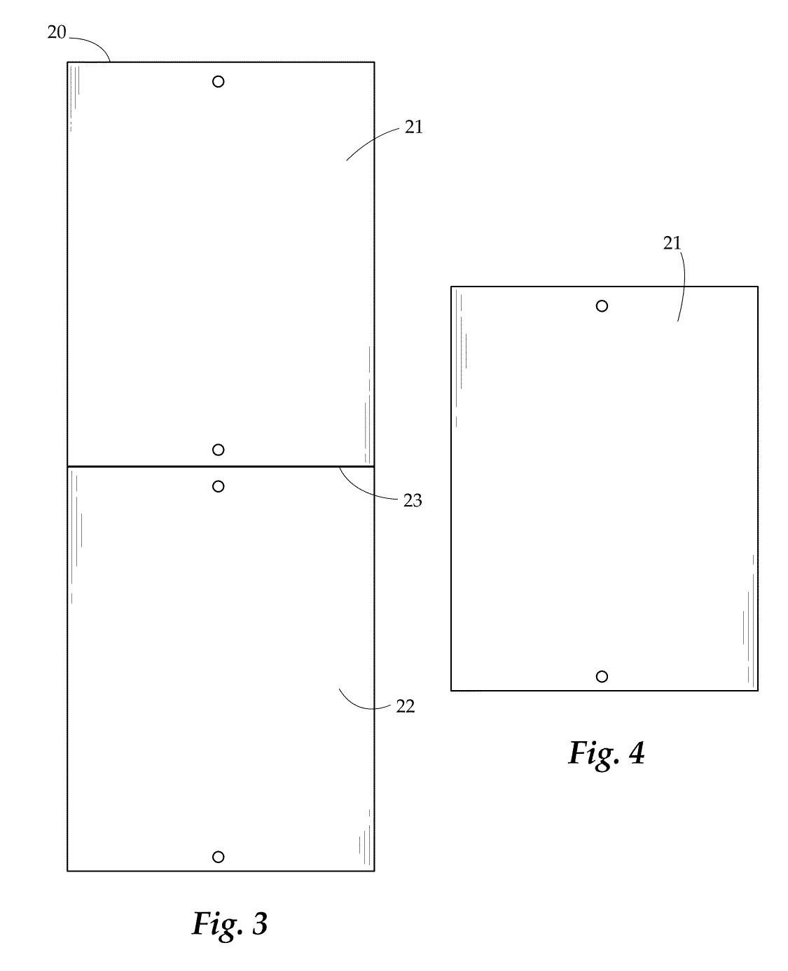

This product can come in many embodiments, one such system is a notebook 20 shown in FIG. 3. The notebook is composed of two sheets 21, 22 of the polymeric erasable panels and is connected using a hinge of the same material 23. FIG. 4 illustrates this embodiment in closed form with the front surface of the panel 21 facing up. These notebooks can be used for business or educational use with the natural lines from the corrugation forming a means to guide text. These notebooks can also be permanently printed on with grids, lines, or drawings via personalization by the user. The polymeric erasable surface allows reuse so that these eco-friendly notebooks can reduce the demand for paper products.

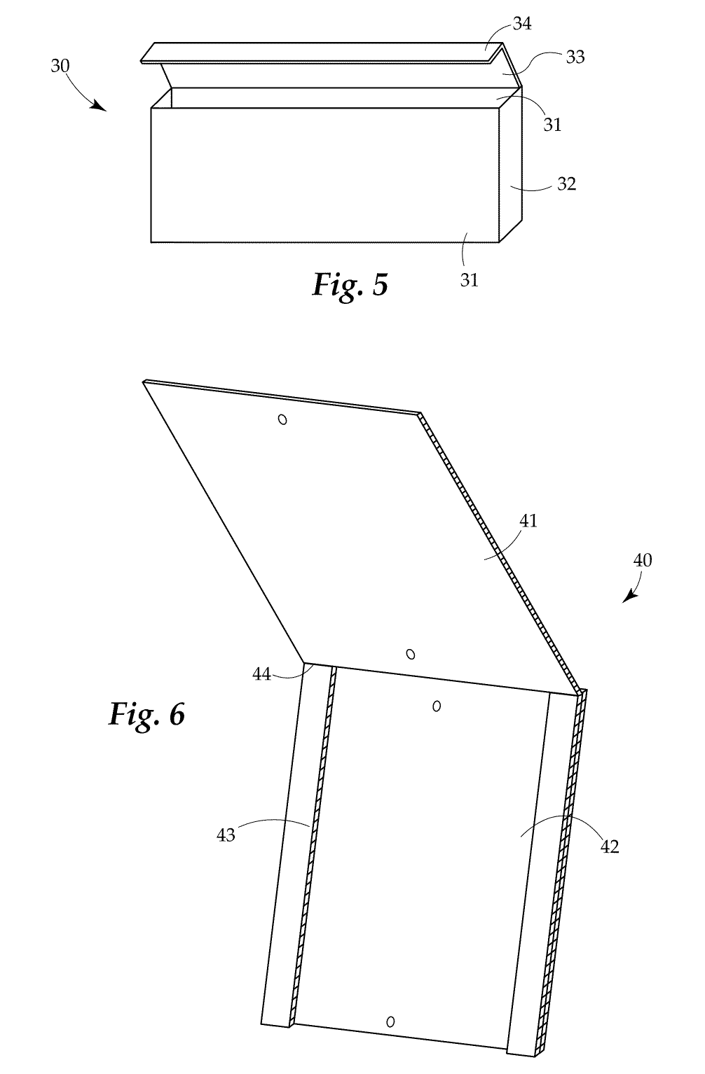

Another embodiment of this invention is a box, envelope or otherwise container 30 as seen in FIG. 5. This box is solidly formed by folding and bonding one piece of the corrugated plastic sheet 31 so as to form a U-shape. The box 30 can also be formed by attaching separate pieces to form the front, back, and bottom using internal pins, rivets, and beams (70, 71, 72, 73 as seen in FIG. 11-14) that can maintain the outside aesthetic while giving the user a sturdy item. The building method used will demand on the user's requirements and dimensions of the box. The box 30 can also feature side pieces 32 adhered by bonding through melting the plastic together or the internal clip method. The box 30 can be left open on top or can be made to close by adhering a lid 33 that can feature a lip 34 which can be made by folding 33 or by adhering a new piece.

Another embodiment of this invention is a three dimensional notebook 40 as seen in FIG. 6. The notebook is composed of two sheets 41, 42 of the polymeric erasable panels and is connected using a hinge of the same material 44. An additional strip 43 is adhered to both sides of the rear panel 42 in order to create a hollow bed that when the notebook is closed is capable of holding supplies.

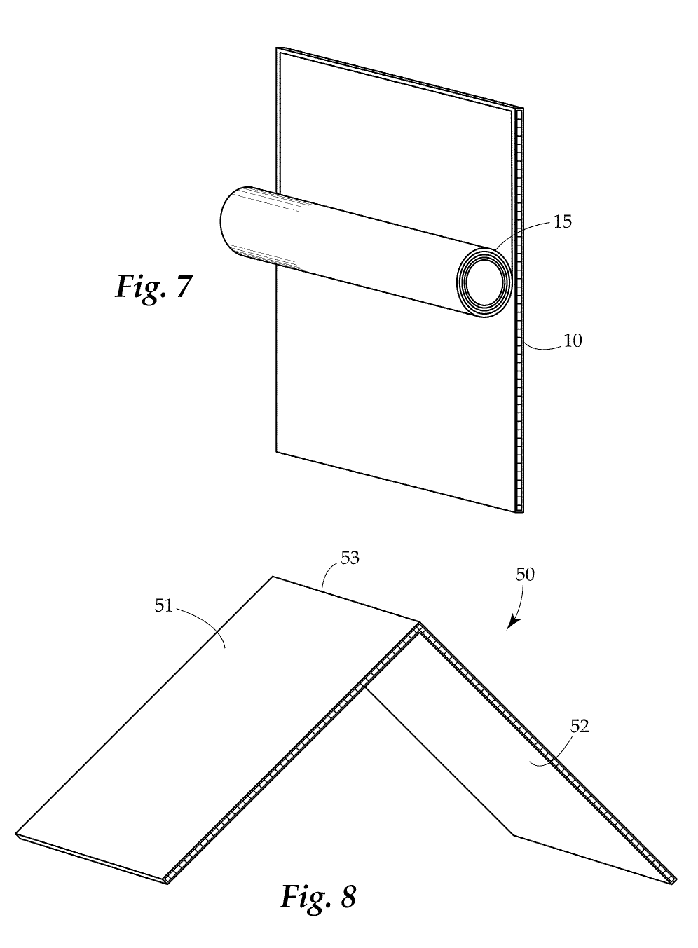

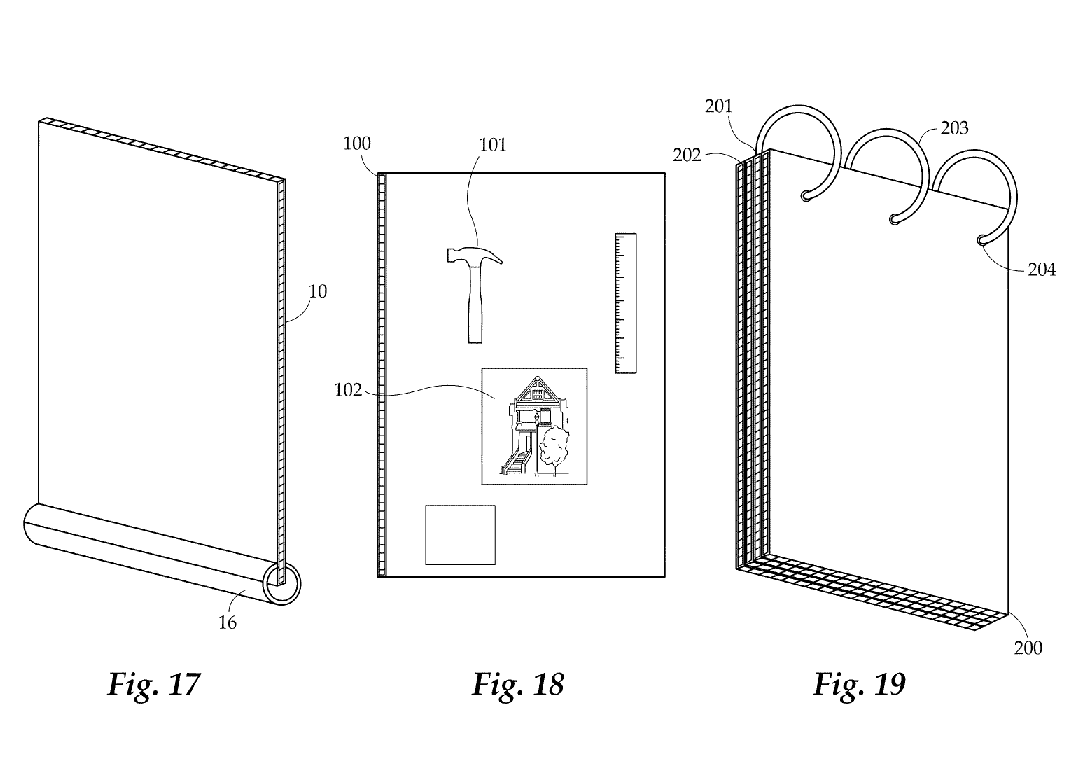

The present invention can also be made with accessories that increase the ease of use and functionality of the polymeric erasable surfaces. In FIG. 7 a laminate sheet 15 is shown being placed over a standard polymeric erasable sheet 10. This laminate 15 better protects the surface and can also be written on if a user wants to further layer their creations. Another accessory is seen in FIG. 17. A finishing strip 16 can be adhered to the edge of any standard polymeric erasable sheet 10 and allows for further protection for the user from sharp edges and is aesthetically pleasing for users seeking to display their product.

Another embodiment of this invention is an a-frame display 50 as seen in FIG. 8. This a-frame 50 can be used commercially as a sign for curb or window display but can also be used for student projects, classroom, easels, children's play toys, etc. The display 50 is formed by two panels 51, 52 that are attached using a hinge 53 similarly to the notebook design. The display can also be reinforced with internal pins, rivets, or beams (70, 71, 72, 73 as seen in FIG. 11-14) to ensure that the structure is supported. The use of external screws is also possible.

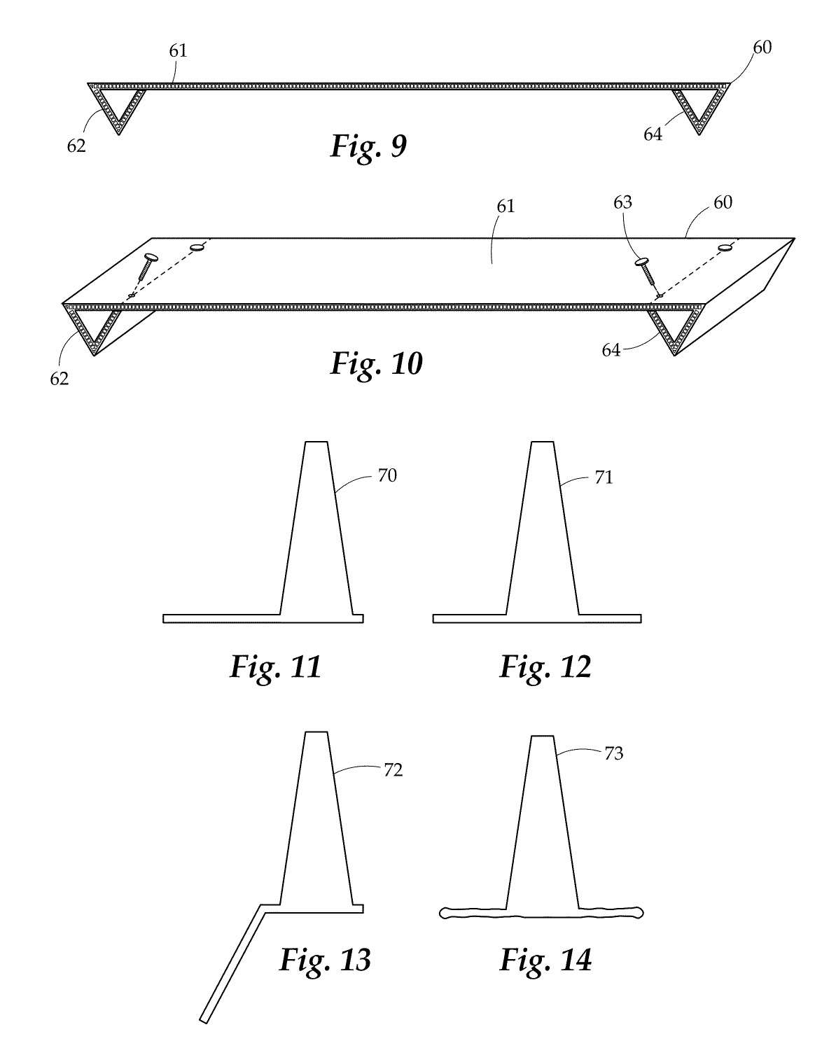

A further embodiment of this invention is a lap table or other small shelf 60 as seen in FIG. 9 and FIG. 10. The lap desk 60 is composed of a top panel 61 and two legs 62, 64. These legs can be made by folding the top panel 60 twice thus forming an under mounted triangle or can be formed by adhering additional piece to the top panel. The legs are secured in place to ensure a properly supported structure by the use of screws 63.

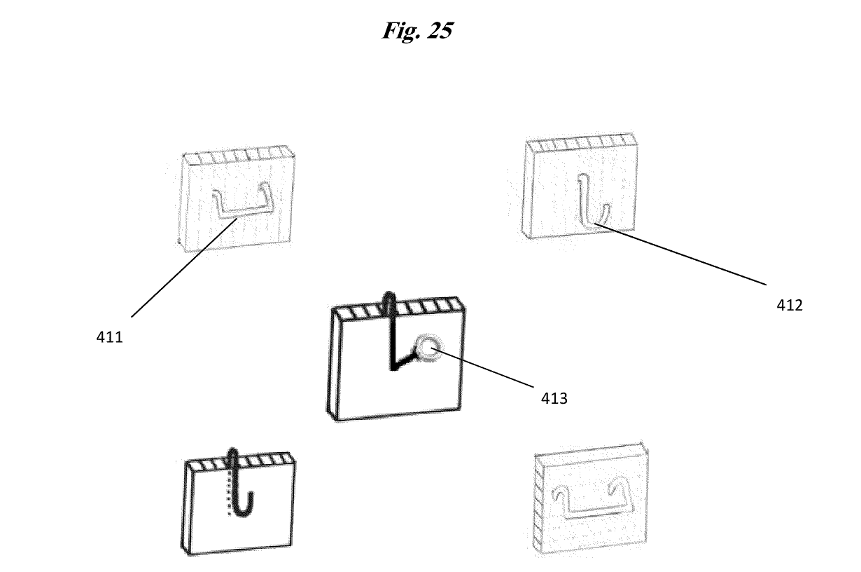

An additional embodiment of the instant system illustrates a system for the interior of vehicles which is disposed to utilize Velcro® or other such positioning systems splayed across a dash board or other such area and utilize a U-shaped mechanism 411 or a C-shaped mechanism 412 as illustrated in FIG. 25 in order to support objects such as a coffee cup holder.

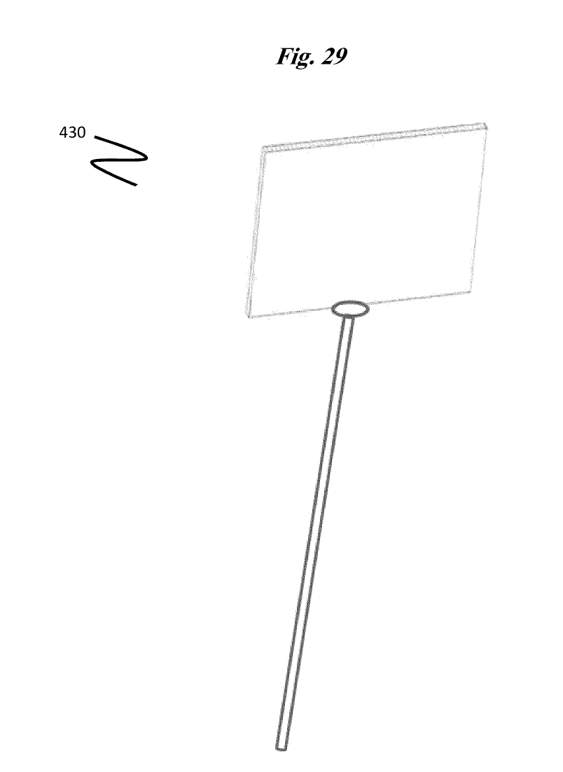

Also, as illustrated in FIG. 29, in one embodiment, an extremely light weight painting assistance mechanism 430 that affords the user the ability to paint shelves and walls and tight areas and not have to tape off or cut in areas as the instant system can easily be held in place.

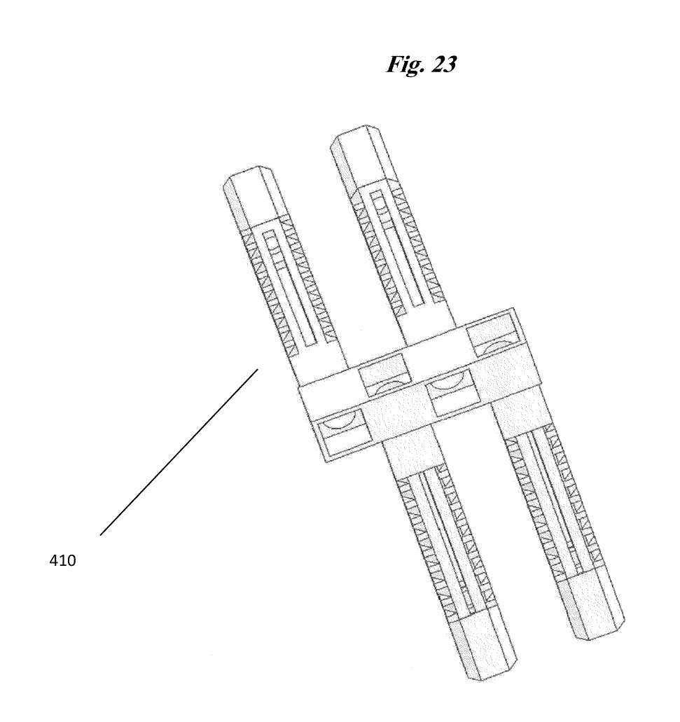

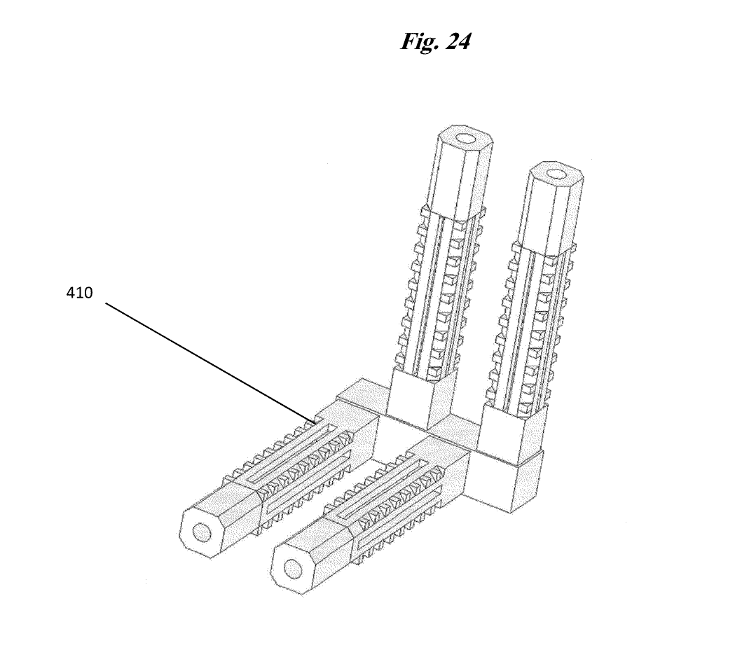

Additionally, the instant system may comprise an embodiment wherein extremely lightweight, maneuverable, writable erasable boards for classrooms usage, which also double as mechanisms to receive screen projections, are introduced. FIG. 23 illustrates a front isometric view of a multipronged pin apparatus 410 which is utilized to join individual elements of the write erasable, corrugated system wherein the double pin configuration eliminates rotation on corners. The pin may include two prongs, four prongs or as many even or odd pronged iterations as necessary. Additionally, connecting pins scan be configured at any angle whatsoever including but not limited to 30 degree, 45 degree, 90 degree, 120 degree . . . etc., as the situation demands.

An additional feature of the smaller boards as well as the notebooks and binders, have the benefit of being “better in the wind” or while holding upright, unlike paper. Furthermore, the instant notebook 450 affords the user a sturdy place to write on paper with. For example, the utility can be seen in situations like signing a check in your car at the drive thru of your bank or for contractors taking notes at a site. The instant system great with a standard pen . . . they write beautifully, have inherent lines, don't flop around, are erasable, mobile and reusable, can get wet without losing information, and provide a sound surface for writing on paper. And foldable whiteboards and notebooks also inherently allow for storage within the multiple folds.

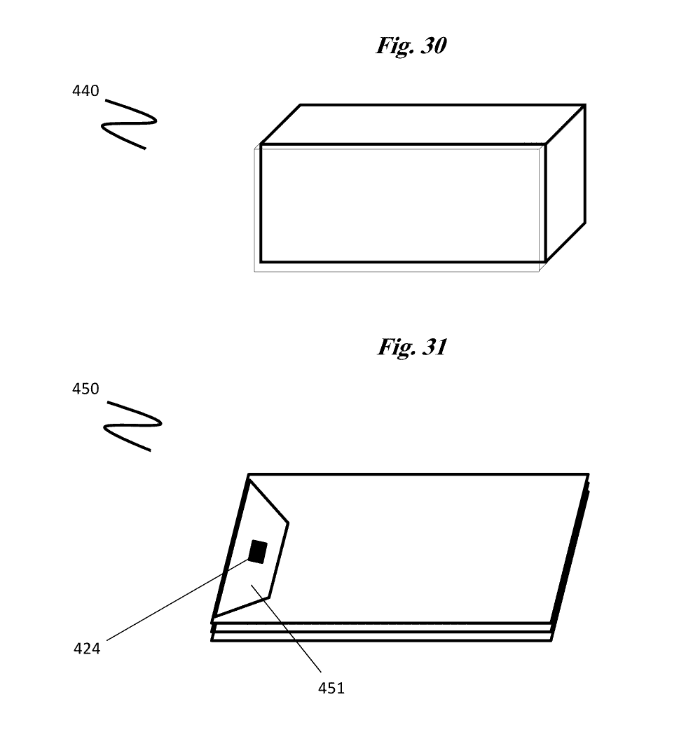

Further, as illustrated in FIG. 31, the instant notebook embodiment a securing flap 451 to ensure closure and integrity of the corrugated notebook may be realized. Further, a button, latch or other securing mechanism, here shown as a Velro® 424 hook and loop system, may be utilized to lock the notebook or binder 451. Further, as illustrated in FIG. 30, a glycol ether erasable coating 440 or any other kind of coating may be utilized to enhance erase ability on the note book, or any of the instantly presented systems.

Along the line of more novelty or gimmick items, a write erasable pet carrier which is easily cleanable and extremely light and sturdy, cut out dress holder in shape of a dress comprising pegs to hold accessories, jewelry and a myriad of children's toys.

In order to adhere the polymeric erasable sheets to one another and ensure strong structure as well as utilizing various embodiments the corrugation of the sheets allows for the use of pins 70, 71, 72, 73 (as seen in FIG. 11-14). These pins can be metal and in the present invention form an L-shape allowing one leg to insert into the corrugated panel and the other to allow for mounting or insert into another panel or other device.

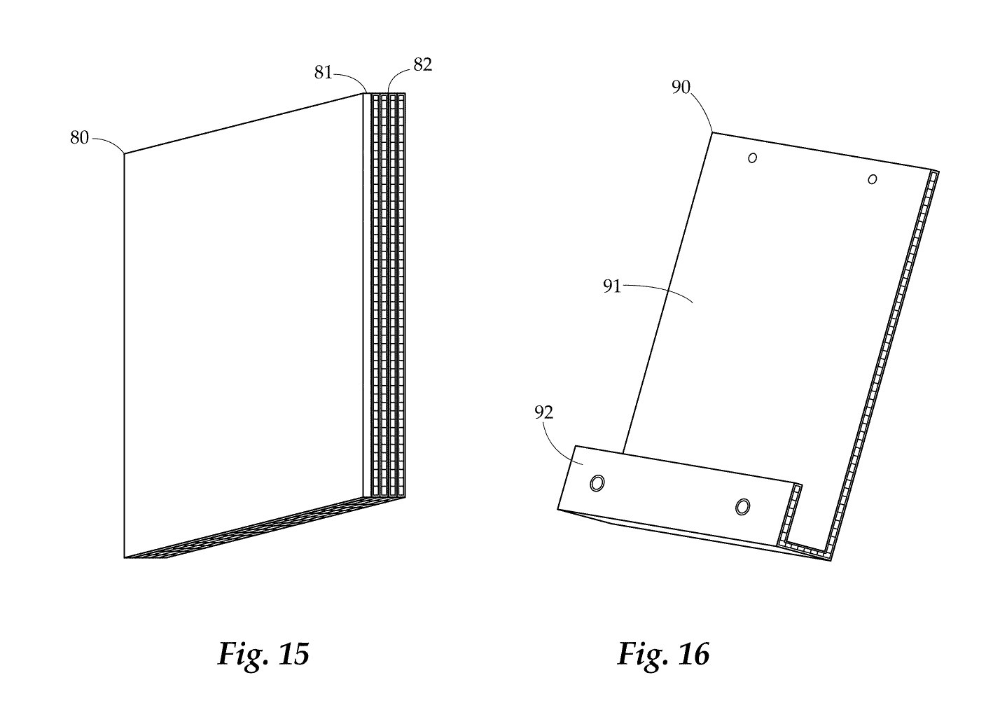

Another embodiment of this invention is a bound stack of sheets 80 as seen in FIG. 15. A stack of sheets 80 may be dimensionally desirable for user seeking to use the surface as a table or other standing structure. The stack can consist of adhered panels 81, 82 that combined create any size block that the user desires.

Another embodiment of this invention is a board with a tray 90 as seen in FIG. 16. A sheet 91 can be folded twice to form a bed with a lip 92. These folds can be reinforced by bonding. The tray 92 can also be formed by adhering additional pieces adhered by using internal pins, rivets, or beams (70, 71, 72, 73 as seen in FIG. 11-14). The tray function would allow users to store markers and washing fluid near the board or to hold any additional supplies desired.

Another embodiment of this invention is a workbench toll organizational board 100 as seen in FIG. 18. This large form board can feature permanent ink outlines of tools 101 or other labels for organization 102. This function allows organization without the outlines wearing off or being ruined, and can be customized.

Another embodiment of this invention is a notepad 200 as seen in FIG. 19. The notepad features multiple sheets 201, 202 that are assembled by punching holes in the sheets 204 and inserting rings 203. These rings 203 can be made of metal, plastic or any other composite material and can vary in size depending on the number of sheets desired. The rings 203 could feature a clip or other device which would allow the rings to open and for sheets to be removed or additional sheets added. The notepad 200 could be used for grocery lists or other task lists around the home, or could be used in place of children's coloring books. In FIG. 19 the notepad 200 could feature permanent drawings, such as the symbols and shapes 205, 206 used in the drawing or any other image. With a permanent design the notepad 200 could easily be used as a child's coloring book, or teaching aids for children.

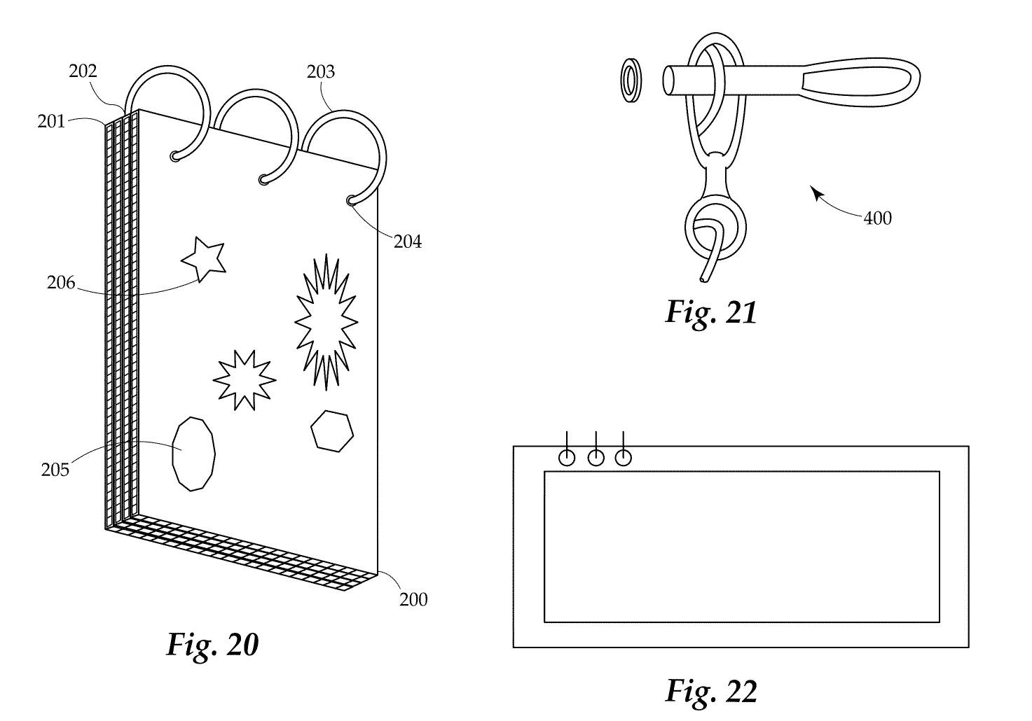

Due to the durable nature of the material FIG. 20 highlights the ability to notch the sheets creating a cut-through 301 that allow for the sheets 300 to be used in various building settings. The cut-through 301 would also allow for string or other materials to loop through the material and create a hanging apparatus. In order to create containers or closable elements with the material as shown in FIG. 5 and FIG. 6 a clasp can be used. Such a clasp 400 is shown in FIG. 21.

As mentioned throughout, the permanent writable and erasable capabilities discussed herein may be adapted to several embodiments and may even be utilized to refinish entire rooms or even play houses for children in order to create an artistic, write erasable environment which may also include embedded, permanent images such as artistic renderings, paintings, interactive board games such tic-tac-toe and others, learning materials or any number of graphic images as the art provides.

In one embodiment, a dual sided hanging display apparatus, which can also be converted into several other applicable apparatuses, is existent. The dual sided hanging display apparatus may comprise at least one polymeric erasable board having writable and erasable surfaces comprising, a front panel and a rear panel. The front panel and the rear panel may be interconnected by a set of parallel members in a substantially perpendicular disposition to both the front panel and the rear panel.

The dual sided hanging display apparatus may further comprise non-erasable imbedded images within the front panel and the rear panel further. And, the dual sided hanging display apparatus may further comprise a set of laminate screen members adhered to the set of outer surfaces of the front panel and the rear panel. Additionally, the front panel and the rear panel further may comprise a glycol ether erasable coating. Also, an or an alcohol base eraser system may be used on pen whereas the glycol ether embodiment is better adapted for permanent markers.

In an additional embodiment of the instant system of corrugated, writable and erasable apparatuses, a corrugated polymeric binding mechanism comprising a uni-planar construction which additionally comprises two, three, twenty or more panels is illustrated. And in one embodiment, the corrugated polymeric binding mechanism may comprise a first panel comprising two sides, a second panel comprising two sides and one or more hinge mechanisms. In practice, the first panel and the second panel may be rotatably attached by the hinge mechanism and in one embodiment the two sides of the first panel and the two sides of the second panel comprise a write erasable material. The corrugated polymeric binding mechanism may also double as a self-standing display face array.

The corrugated polymeric binding mechanism may comprise three panels, twenty panels or more, and two or more hinge mechanisms to accommodate the number of panels and display faces utilized. Furthermore, the corrugated polymeric notebook may define one or more internally disposed storage areas, depending upon the number of panels display faces utilized. Moreover, the panels or display faces of the corrugated polymeric binding mechanism may also comprise a permanently applied printed under coat image and may also comprise a set of laminate screen members adhered to the set of outer surfaces.

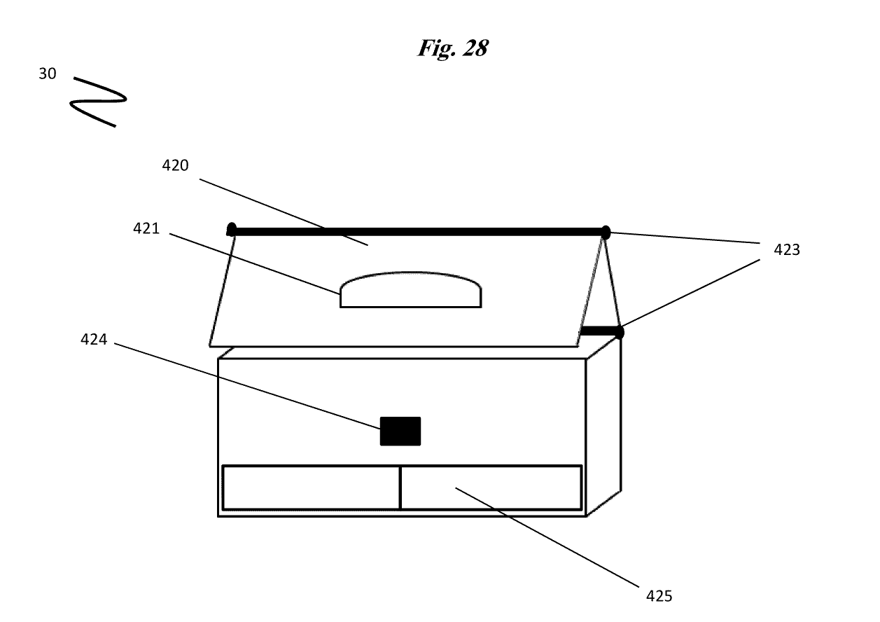

In a further embodiment, a multi-function, write erasable, storage and/or carrying case 30, also including but not limited to, tool box 30, or mailbox 30, which may be utilized as a tool case may be revealed. This case may include a flexible, foldable handle 33, 420 in FIG. 28 which may take shapes, such as a triangular arrangement, for one instance only. The storage/carrying apparatus 30 may comprise a set of corrugated upper interlocked partition members 31 wherein the interlocked partition members 31 are disposed in the same plane comprising a set of inner surfaces and a set of outer surfaces, at least one corrugated lower partition member, and at least one corrugated handle member comprising at least one through aperture 421. The handle 33, 420 may take numerous shapes in different embodiments for instance, the corrugated handle member may comprise a centrally disposed hinge mechanism and at least two corrugated handle members with two though apertures, wherein each of the handle members includes one of the two apertures.

Furthermore, each individual of the set of interlocked partition members may comprise a pair of outer members and a set of inner rib members and the set of interlocked partition members may comprise five interlocked partition members and the set of interlocked partition members comprises six interlocked partition members. Furthermore, the corrugated handle member may be attached by a hinge mechanism 423 to the upper edge of an individual of the set of corrugated upper interlocked partition members and the handle member may also possess a divided handle portion with a hinge mechanism 423 to add extra flexibility. Thus, the handle may comprise two individual members in rotatable communication and the entire unit in rotatable communication. Like all of the other apparatuses revealed herein, including but not limited the reversible boards, notebooks, and binders, the instant toolbox or mailbox may comprise pockets 425 for storage as illustrated in FIG. 28

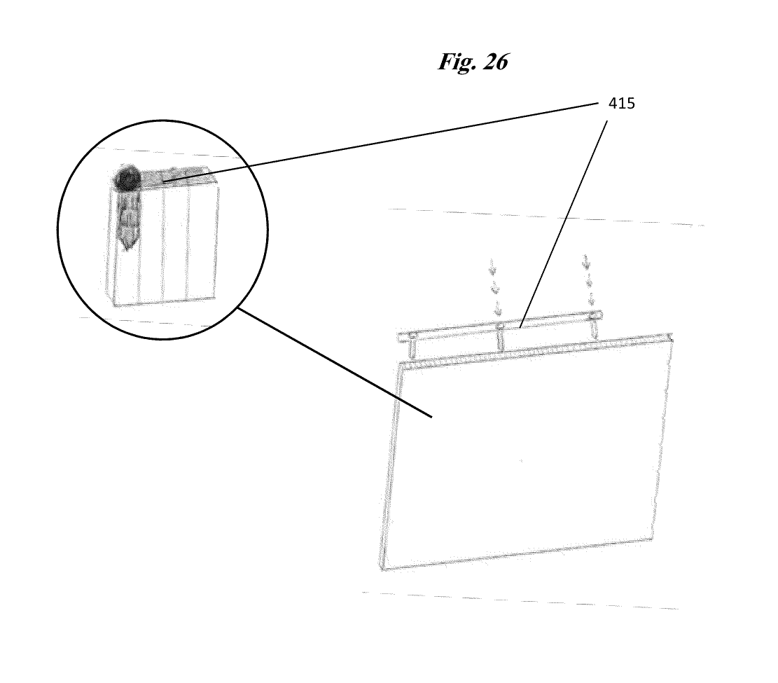

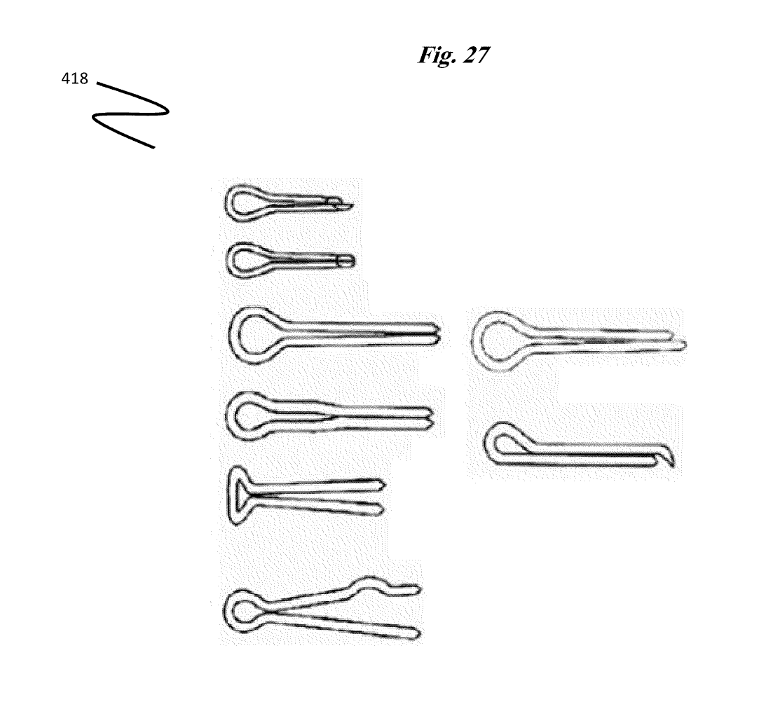

The storage apparatus may also comprise a substantially rectangular shape wherein all outer surfaces comprise erasable surfaces, a permanently applied printed under coat image and a set of laminate screen members which may be adhered to the set of outer surfaces. Moreover, the instant embodiment may also comprise a wall mounting system using any of the clipping, affixing or adhering mechanisms illustrated in FIGS. 23-28, including physical clips, screws or Velcro®, or any other affixing mechanism known in the art, which thus reveals and added functionality to the system as additional clips may be clipped into three outer walls that are not clipped or mounted. Thus, the storage apparatus may comprise a portable or mountable storage apparatus which, by utilizing the numerous slots inherent through the corrugated construction, allows for the mounted mailbox, a mounted or portable toolbox, a storage bin system, a stackable bin system and any number of storage or containment apparatuses.

In an additional embodiment, a reinforced composite writable structural element is revealed. Additionally, the reinforced composite writable structural element may comprising an outer layer, a median layer and an inner layer wherein the outer layer is attached to the median layer in a perpendicular manner and the median layer is attached to the inner layer in a perpendicular manner. The outer layer is composed of a thermoplastic polymer and may comprise a permanently applied printed under coat image and a set of laminate screen members adhered to the set of outer surfaces.

The reinforced composite writable structural element may be utilized to manufacture products selected from the group consisting of a writable pictures, peg boards, doghouses, birdhouses, tool sheds, yard sheds, ice-fishing sheds, toy boxes, doll houses, white boards, containers, displays, frames, notebooks, children's toys, books, pegboards, lap tables, easels, signage, storage organizations, saw horses and write-erasable wall coverings.

In an exemplary embodiment, a corrugated notebook device is revealed, this device may comprise at least two parallel planar members joined by a set of interior rectangular members in perpendicular relation to the two parallel planar members. Furthermore, at least one segment of an individual of the at least two parallel planar members may be severed in at least one point between two individual of the set of interior rectangular members to form at least two facing members in hinged communication. Additionally, at least two of the parallel planar members may severed at two points between two individual of the set of interior rectangular members to form a hinge and the system may comprise between 3 and 20 of the facing members. Moreover, the facing members may comprise a permanently applied printed under coat image and a set of laminate screen members adhered to the set of outer surfaces.

In an added embodiment, a combined flexible saw horse and signage apparatus is illustrated and may comprising a first leg comprising a series of rectangular receiving areas and an outer writable and erasable surface, a second leg comprising a series of rectangular receiving areas corresponding with the first leg rectangular receiving areas. The combined flexible saw horse and signage apparatus my also comprise a removably attached joiner apparatus which may comprising at least two interconnecting pin mechanisms, wherein the removably attached joiner apparatus may be inserted simultaneously into the first leg series of rectangular receiving areas and the second leg series of rectangular receiving areas. And, the two interconnecting pin mechanisms may comprises four interconnecting pin mechanisms and the outer writable and erasable surface may comprise a permanently applied printed under coat image and a set of laminate screen members adhered to the set of outer surfaces.

In an additional configuration, a combined signage, projection receiving/displaying and peg board system which may comprise a storage and attachment member comprising a set of vertically disposed rectangular receiving pocket members defined and formed from two parallel members attached by a set of perpendicular joinder members and a removably affixed attachment mechanism. The combined signage, projection receiving/displaying and peg board system may also comprise a reversible sign member comprising at least two parallel members attached by a set of perpendicular joinder members which define a set of rectangular areas and at least two write erasable outer surfaces. And, the combined signage, projection receiving/displaying and peg board system may also comprise at least one retaining mechanism comprising an outer diameter substantially equal to the set of rectangular areas, and the at least one retaining mechanism may be removably attachable and attached.

In addition, the attachment mechanism of the combined sign, projection receiving/displaying and peg board system may comprise an outer diameter substantially equal to the diameter of the largest possible circular member inscribed within an individual of the set of rectangular areas and may also comprise an outer area substantially equal to an inner area of an individual of the set of rectangular areas. Moreover, the at least one retaining mechanism may comprise 10, 20 or as many retaining mechanisms as may be fitted within the confines of the specifically designed apparatus. The retaining mechanisms may be selected from the group consisting of fitted pegs, fitted eye hooks 413, dowl pins, and cotter pins 418 and multipronged pegs 410 as illustrated in FIGS. 23-28 and as the state of the art dictates.

Further, most materials may be utilized for the fastening members, including hard and soft metals, polymers, hardened polymers, composites, including carbon fiber as the situation and the state of the art dictate. Finally, the combined sign, projection and peg board system may comprise a permanently applied printed under coat image and a set of laminate screen members adhered to the set of outer surfaces for enhanced printing and erasability.

In an complimentary embodiment, a reversible peg board and dry marker board system is revealed and this system may comprising at least two parallel rectangular sheets of extruded, polypropylene copolymer in communication with a set of substantially rectangular joinder members comprising extruded, polypropylene copolymer. To further enhance the system, at least one removably attached mounting member and a set of removably attached peg mechanisms may be utilized. To enhance the capability of the system, the reversible peg board and dry marker board may attach a set of removably attached peg mechanisms selected from the group consisting of u-bolts, c-bolts, j-bolts, eye bolts, hangar bolts, screw eye bolts, forged eye bolts, wire eye bolts, wire eye lags, pins, cotter pins, elevator bolts, rivets, blind rivets and these pegs may comprise materials selected from the group consisting of stainless steel, zinc plated steel, brass, silicon bronze, polymers, and composites. The parallel rectangular sheets of extruded, polypropylene copolymer may comprise a permanently applied printed under coat image adhered to a set of outer surfaces and may comprise a set of laminate screen members adhered to a set of outer surfaces.

1. A dual sided hanging display apparatus comprising:
at least one polymeric erasable boards having writable and erasable surfaces comprising:
a front panel;
a rear panel; wherein the front panel and the rear panel are interconnected by a set of parallel members in a substantially perpendicular disposition to both the front panel and the rear panel.

2. The dual sided hanging display apparatus of claim 1 wherein the front panel and the rear panel further comprise non-erasable imbedded images.

3. The dual sided hanging display apparatus of claim 1 wherein the front panel and the rear panel comprise a set of laminate screen members adhered to the set of outer surfaces.

4. The dual sided hanging display apparatus of claim 1 wherein the front panel and the rear panel further comprise a glycol ether erasable coating.

5. A corrugated polymeric binding mechanism comprising a uni-planar construction comprising:
at least two panels comprising:
a first panel comprising two sides;
a second panel comprising two sides; and
at least one hinge mechanism; wherein the first panel and the second panel are rotatably attached by the hinge mechanism.

6. The corrugated polymeric binding mechanism of claim 5 wherein the two sides of the first panel and the two sides of the second panel comprise a write erasable material.

7. The corrugated polymeric binding mechanism of claim 5 wherein the at least two panels comprise three panels and the at least one hinge mechanism comprises two hinge mechanisms and wherein corrugated polymeric notebook comprises a storage area and a range of panels between 3 and 20.

8. The corrugated polymeric binding mechanism of claim 5 wherein at least one of the at least two panels comprises a permanently applied printed under coat image.

9. The corrugated polymeric binding mechanism of claim 5 wherein at least one of the at least two panels comprises a set of laminate screen members adhered to the set of outer surfaces.

10. A reinforced composite writable erasable structural element comprising:
an outer layer;
a median layer; and
an inner layer; wherein the outer layer is attached to the median layer in a perpendicular manner and wherein the median layer is attached to the inner layer in a perpendicular manner and wherein the outer layer is composed of a thermoplastic polymer.

11. The reinforced composite writable erasable structural element of claim 10 wherein a set of the reinforced composite writable erasable structural elements comprise a storage apparatus comprising:
a set of corrugated upper interlocked partition members wherein the interlocked partition members are disposed in the same plane comprising a set of inner surfaces and a set of outer surfaces;
at least one corrugated lower partition member; and,
at least one corrugated handle member comprising at least one through aperture.

12. The storage apparatus of claim 11 wherein each individual of the set of interlocked partition members comprises a pair of outer members and a set of inner rib members.

13. The storage apparatus of claim 11 wherein the set of interlocked partition members comprises five or six interlocked partition members.

14. The storage apparatus of claim 11 wherein the at least one corrugated handle member is hingedly attached to the upper edge of an individual of the set of corrugated upper interlocked partition members.

15. The storage apparatus of claim 14 wherein the at least one corrugated handle member comprises a centrally disposed hinge mechanism.

16. The storage apparatus of claim 11 wherein the at least one corrugated handle member further comprises at least two corrugated handle members and the at least one through aperture comprises at least two though apertures, wherein each of the at least two corrugated handle members comprises one of the at least two apertures.

17. The storage apparatus of claim 11 wherein the storage apparatus comprises substantially rectangular shape wherein all outer surfaces comprise erasable surfaces.

18. The storage apparatus of claim 11 wherein the set of outer surfaces of the corrugated upper interlocked partition members comprise a permanently applied printed under coat image.

19. The storage apparatus of claim 11 wherein the corrugated upper interlocked partition members comprise a set of laminate screen members adhered to the set of outer surfaces.

20. The storage apparatus of claim 11 wherein the storage apparatus comprises a wall mounting system and may comprise components which are selected from the group consisting of a portable mailbox, a portable toolbox, a mounted mailbox, a portable toolbox, and a storage bin system.

21-47. (canceled)
